(19) United States
(12) Patent Application Publication
(10) Pub. No.: US 2026/0109426 A1
(43) Pub. Date: Apr. 23, 2026

(54) STRADDLE VEHICLE

(71) Applicant: KAWASAKI MOTORS, LTD., Akashi-shi (JP)

(72) Inventors: Tomo YAMAMOTO, Akashi-shi (JP); Toya TAKAHASHI, Akashi-shi (JP)

(21) Appl. No.: 19/363,218

(22) Filed: Oct. 20, 2025

(30) Foreign Application Priority Data
Oct. 21, 2024 (JP) 2024-185240

(51) Int. Cl. B62K 25/28; B62J 1/08; B62K 11/04

(52) U.S. Cl. CPC B62K 25/283; B62J 1/08; B62K 11/04

(57) ABSTRACT

A straddle vehicle includes: a pair of top frames; a pair of pivot frames each of which is connected to a rear end of a corresponding one of the pair of top frames; a cross frame coupling the pair of top frames or the pair of pivot frames to each other; a swing arm pivotally coupled to the pair of pivot frames; a bracket extending from the cross frame; and a rear suspension pivotally connected at an upper end to the bracket and at a lower end to the swing arm. In a side view of the straddle vehicle, a first line extending from a pivotal axis of the upper end of the rear suspension to a pivotal axis of the lower end of the rear suspension passes through the cross frame.

### CROSS-REFERENCE TO RELATED APPLICATION

This application claims priority to and the benefit of Japanese Patent Application No. 2024-185240, filed on Oct. 21, 2024, the entire disclosure of which is incorporated herein by reference.

### BACKGROUND ART

### Field of the Invention

The present disclosure relates to straddle vehicles.

### Description of the Related Art

Japanese U.S. Pat. No. 6,008,920 discloses a straddle vehicle including a swing arm, left and right pivot frames pivotally supporting the swing arm, and a cross member coupling the left and right pivot frames to each other. The straddle vehicle further includes a rear suspension having an upper support located at a distal end of a bracket extending forward and downward from the cross member.

In the straddle vehicle of Japanese U.S. Pat. No. 6,008,920, extension or contraction of the rear suspension generates a moment acting on the bracket in a rotational direction about the cross member. The structure for mounting the bracket to the cross member is required to have a certain level of strength, and might be large in size or structurally complex.

### SUMMARY OF THE INVENTION

An object of one aspect of the present disclosure is to provide a straddle vehicle that ensures sufficient strength at a mounting portion of a rear suspension through a simple structure.

A straddle vehicle according to one aspect of the present disclosure includes: a pair of top frames extending in a forward/backward direction of the straddle vehicle; a pair of pivot frames each of which is connected to a rear end of a corresponding one of the pair of top frames, the pivot frames extending in a downward direction of the straddle vehicle; a cross frame extending in a leftward/rightward direction of the straddle vehicle and coupling the pair of top frames or the pair of pivot frames to each other; a swing arm pivotally coupled to the pair of pivot frames and supporting a rear wheel of the straddle vehicle; a bracket extending from the cross frame in the downward direction; and a rear suspension having an upper end and a lower end, the rear suspension being pivotally connected at the upper end to the bracket and at the lower end to the swing arm, wherein in a side view of the straddle vehicle, a first line extending from a pivotal axis of the upper end of the rear suspension to a pivotal axis of the lower end of the rear suspension passes through the cross frame.

### BRIEF DESCRIPTION OF THE DRAWINGS

FIG. 1 is a side view showing an example of the configuration of a straddle vehicle according to an exemplary embodiment.

FIG. 2 is a left side view showing a vehicle body frame of the motorcycle of FIG. 1.

FIG. 3 is a right side view showing the vehicle body frame of the motorcycle of FIG. 1.

FIG. 4 is a plan view showing the vehicle body frame of the motorcycle of FIG. 1 as viewed from above.

FIG. 5 is a perspective view showing the vehicle body frame of the motorcycle of FIG. 1 as viewed obliquely from the front.

FIG. 6 is a perspective view showing the vehicle body frame of the motorcycle of FIG. 1 as viewed obliquely from below.

FIG. 7 is an enlarged left side view showing a rear suspension and its vicinity on the vehicle body frame of FIG. 2.

FIG. 8 is a plan view showing the vehicle body frame of the motorcycle of FIG. 1 as viewed from below.

FIG. 9 is a left side view showing the rear suspension and its neighboring components, similarly to FIG. 7.

### DETAILED DESCRIPTION

Hereinafter, an exemplary embodiment of the present disclosure will be described with reference to the drawings. The embodiment described below is a generic or specific example. Some elements in the embodiment described below are not included in the appended independent claims that define the broadest concept of the present disclosure, and these elements are described as optional elements. The figures in the accompanying drawings are schematic, and the elements depicted are not necessarily shown with precise dimensions. Elements that are substantially the same are denoted by the same reference signs throughout the drawings, and repeated descriptions thereof may be omitted or simplified. In the following embodiment, the straddle vehicle described is a motorcycle. However, the straddle vehicle may be a motor tricycle or a buggy.

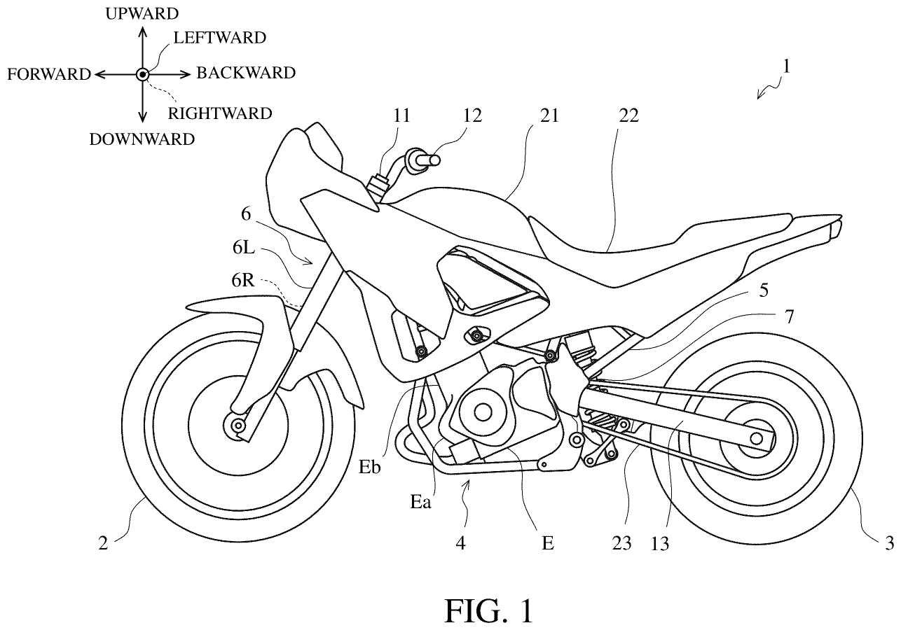

A straddle vehicle 1 according to an exemplary embodiment will now be described. FIG. 1 is a side view showing an example of the configuration of the straddle vehicle 1 according to the exemplary embodiment. As shown in FIG. 1, the straddle vehicle 1 according to the present embodiment is a motorcycle. In the following description, the “straddle vehicle 1” may also be referred to as the “motorcycle 1”.

The motorcycle 1 includes a front wheel 2, a rear wheel 3, a vehicle body frame 4, a seat frame 5, a front suspension 6 supporting the front wheel 2, and a rear suspension 7 supporting the rear wheel 3. In the motorcycle 1 of the present embodiment, the vehicle body frame 4 and the seat frame 5 are integrated with each other. The seat frame 5 is welded to the vehicle body frame 4.

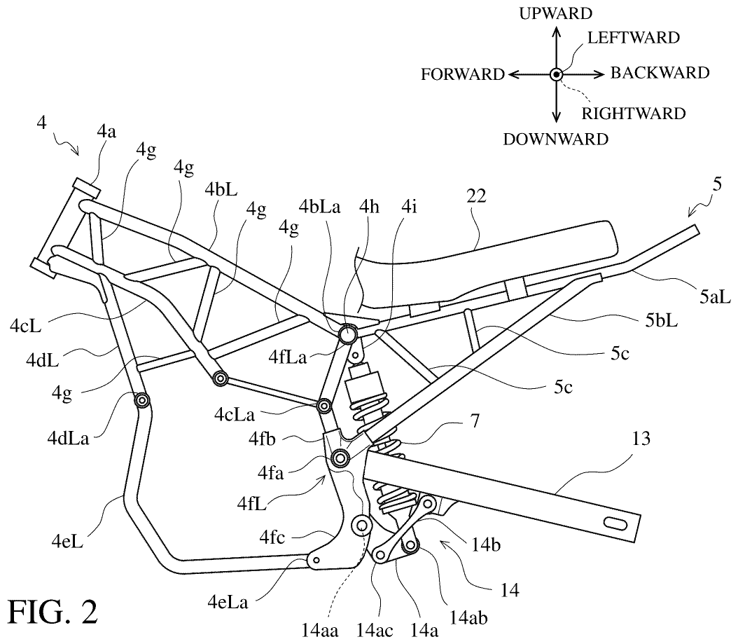

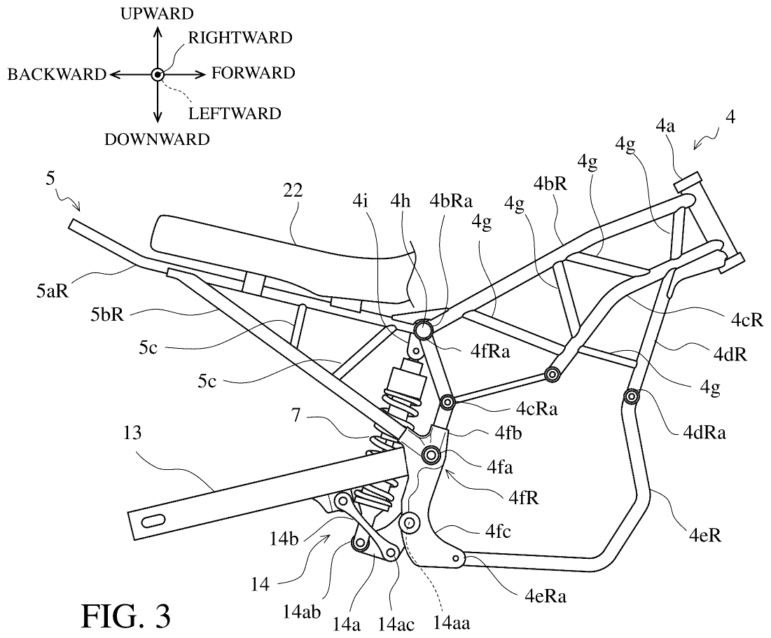

FIGS. 2 and 3 are left and right side views, respectively, of the vehicle body frame 4 of the motorcycle 1 of FIG. 1. As shown in FIGS. 2 and 3, the vehicle body frame 4 includes a head pipe 4a, a pair of upper main frames 4bL and 4bR, a pair of lower main frames 4cL and 4cR, a pair of down frames 4dL and 4dR, a pair of lower frames 4eL and 4eR, a pair of pivot frames 4fL and 4fR, a plurality of bridge frames 4g, and a cross frame 4h. These are collectively referred to as the frame elements of the vehicle body frame 4. In the vehicle body frame 4, at least some of the frame elements are welded together.

In the specification and the claims, the upward, downward, forward, backward, leftward, and rightward directions are defined with respect to the motorcycle 1 placed upright on a ground surface extending horizontally. The upward direction refers to the direction from the ground surface toward the motorcycle 1, while the downward direction refers to the direction from the motorcycle 1 toward the ground surface. The forward direction refers to the direction in which the motorcycle 1 moves ahead. The backward, leftward, and rightward directions refer to those defined with respect to the rider seated astride the motorcycle 1 placed upright on the ground surface.

The head pipe 4a is a cylindrical component having an axis extending in the upward/downward direction. The motorcycle 1 includes a steering shaft 11, which is rotatably inserted into the head pipe 4a.

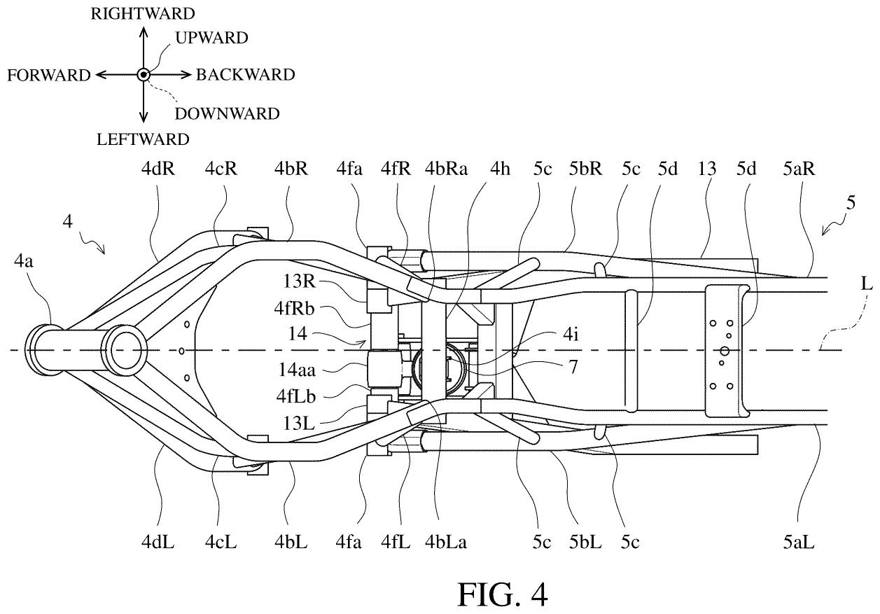

FIG. 4 is a plan view showing the vehicle body frame 4 of the motorcycle 1 of FIG. 1 as viewed from above. As shown in FIG. 4, the upper main frames 4bL and 4bR are opposed to each other in the leftward/rightward direction. The upper main frame 4bL is located to the left of a line L extending through the head pipe 4a in the forward/backward direction of the motorcycle 1, and the upper main frame 4bR is located to the right of the line L. In the present embodiment, the line L passes through the center of the motorcycle 1 in the leftward/rightward direction. The upper main frames 4bL and 4bR extend obliquely downward and backward from an upper portion of the head pipe 4a. The upper main frames 4bL and 4bR extend backward away from the head pipe 4a to respective intermediate points such that the distance between them in the leftward/rightward direction increases. From these points, the upper main frames 4bL and 4bR bend and further extend backward so as to come closer to each other in the leftward/rightward direction. The rear end 4bLa of the upper main frame 4bL is spaced apart from the rear end 4bRa of the upper main frame 4bR in the leftward/rightward direction.

As shown in FIGS. 2 and 3, the lower main frames 4cL and 4cR are opposed to each other in the leftward/rightward direction. The lower main frame 4cL is located to the left of the line L, while the lower main frame 4cR is located to the right of the line L. The lower main frames 4cL and 4cR extend obliquely downward and backward from a lower portion of the head pipe 4a. The lower main frames 4cL and 4cR extend backward away from the head pipe 4a to respective intermediate points such that the distance between them in the leftward/rightward direction increases. From these points, the lower main frames 4cL and 4cR bend and further extend backward so as to come closer to each other in the leftward/rightward direction. The lower main frames 4cL and 4cR are located below the upper main frames 4bL and 4bR. The rear end 4cLa of the lower main frame 4cL is connected to the pivot frame 4fL, and the rear end 4cRa of the lower main frame 4cR is connected to the pivot frame 4fR.

The down frames 4dL and 4dR are opposed to each other in the leftward/rightward direction. The down frame 4dL is located to the left of the line L, while the down frame 4dR is located to the right of the line L. The down frames 4dL and 4dR extend obliquely downward and backward from a lower portion of the head pipe 4a. In the present embodiment, the down frames 4dL and 4dR are joined to the lower main frames 4cL and 4cR, respectively, in the vicinity of the head pipe 4a. Thus, the down frames 4dL and 4dR extend from portions of the lower main frames 4cL and 4cR that are located near the head pipe 4a. The down frames 4dL and 4dR extend below the lower main frames 4cL and 4cR. The down frames 4dL and 4dR extend backward away from the head pipe 4a such that the distance between them in the leftward/rightward direction increases. The rear end 4dLa of the down frame 4dL is spaced apart from the rear end 4dRa of the down frame 4dR in the leftward/rightward direction.

The lower frames 4eL and 4eR are opposed to and spaced apart from each other in the leftward/rightward direction. The lower frame 4eL extends downward from the rear end 4dLa of the down frame 4dL to an intermediate point, from which the lower frame 4eL bends and extends backward. The lower frame 4eR extends downward from the rear end 4dRa of the down frame 4dR to an intermediate point, from which the lower frame 4eR bends and extends backward. The rear end 4eLa of the lower frame 4eL is spaced apart from the rear end 4eRa of the lower frame 4eR in the leftward/rightward direction. The rear end 4eLa of the lower frame 4eL is connected to the pivot frame 4fL. The rear end 4eRa of the lower frame 4eR is connected to the pivot frame 4fR. In the present embodiment, the connections between the lower frame 4eL and the down frame 4dL, between the lower frame 4eR and the down frame 4dR, between the lower frame 4eL and the pivot frame 4fL, and between the lower frame 4eR and the pivot frame 4fR are made using bolts, but may alternatively be accomplished by welding.

The pivot frames 4fL and 4fR are opposed to and spaced apart from each other in the leftward/rightward direction. The pivot frame 4fL is located to the left of the line L, while the pivot frame 4fR is located to the right of the line L. The pivot frames 4fL and 4fR, spaced apart in the leftward/rightward direction, extend in the upward/downward direction. The upper end 4fLa of the pivot frame 4fL is connected to the rear end 4bLa of the upper main frame 4bL. The upper end 4fRa of the pivot frame 4fR is connected to the rear end 4bRa of the upper main frame 4bR.

Each of the pivot frames 4fL and 4fR includes a support portion 4fa that supports a shaft extending in the leftward/rightward direction, with the shaft being rotatable about its own axis. The support portion 4fa is tubular and includes a through hole. The support portion 4fa may include a bearing within the through hole. Each pivot frame 4fL or 4fR includes: an upper region 4fb extending from the upper end 4fLa or 4fRa to the support portion 4fa; and a lower region 4fc extending downward from the upper region 4fb.

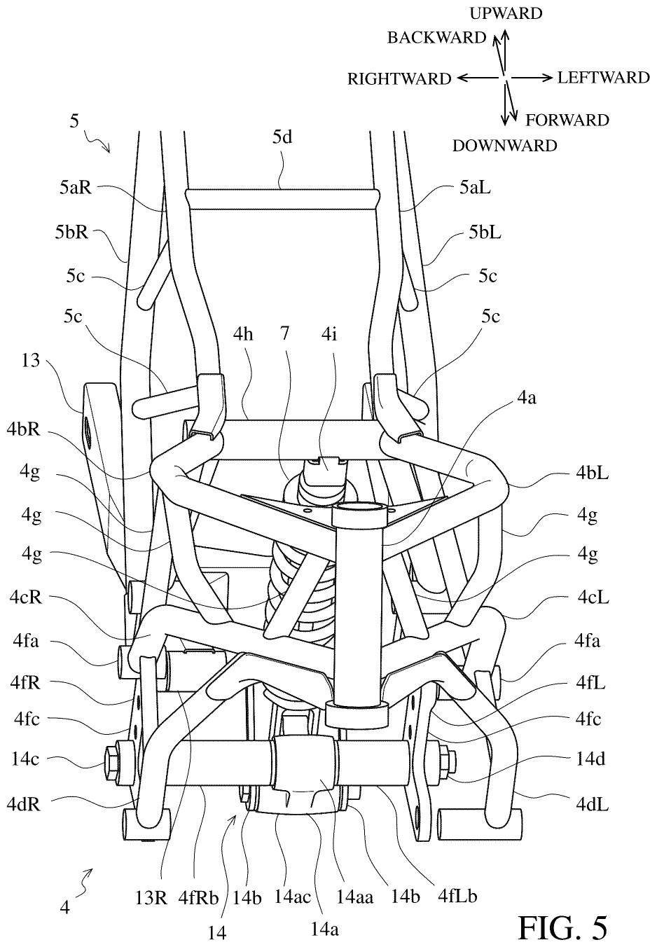

FIG. 5 is a perspective view showing the vehicle body frame 4 of the motorcycle 1 of FIG. 1 as viewed obliquely from the front. As shown in FIG. 4 and FIG. 5, the lower region 4fc of the pivot frame 4fL includes a hollow cylindrical portion 4fLb protruding rightward toward the pivot frame 4fR. The lower region 4fc of the pivot frame 4fR includes a hollow cylindrical portion 4fRb protruding leftward toward the pivot frame 4fL. The cylindrical portions 4fLb and 4fRb are spaced apart by a gap in the leftward/rightward direction. The cylindrical portions 4fLb and 4fRb are examples of the claimed bottom frames.

As shown in FIGS. 2 and 3, the bridge frames 4g couple the upper and lower main frames 4bL and 4cL in a truss pattern. The bridge frames 4g also couple the upper and lower main frames 4bR and 4cR in a truss pattern. The bridge frames 4g couple the lower main frame 4cL to the down frame 4dL. The bridge frames 4g couple the lower main frame 4cR to the down frame 4dR.

The cross frame 4h extends straight in the leftward/rightward direction. The cross frame 4h couples the junction between the upper end 4fLa of the pivot frame 4fL and the rear end 4bLa of the upper main frame 4bL to the junction between the upper end 4fRa of the pivot frame 4fR and the rear end 4bRa of the upper main frame 4bR in the leftward/rightward direction. In the present embodiment, the upper end 4fLa of the pivot frame 4fL and the rear end 4bLa of the upper main frame 4bL are welded to the left end of the cross frame 4h. The upper end 4fRa of the pivot frame 4fR and the rear end 4bRa of the upper main frame 4bR are welded to the right end of the cross frame 4h.

The seat frame 5 is composed of frame elements including a pair of upper seat frames 5aL and 5aR, a pair of lower seat frames 5bL and 5bR, a plurality of seat bridge frames 5c, and a plurality of seat cross frames 5d. The seat cross frames 5d are shown in FIGS. 4 and 5. In the seat frame 5, the frame elements are welded together.

The upper seat frame 5aL is connected to the rear end 4bLa of the upper main frame 4bL and extends backward from the rear end 4bLa. The upper seat frame 5aR is connected to the rear end 4bRa of the upper main frame 4bR and extends backward from the rear end 4bRa. The upper seat frame 5aL is connected to the junction between the rear end 4bLa and the upper end 4fLa of the pivot frame 4fL. The upper seat frame 5aR is connected to the junction between the rear end 4bRa and the upper end 4fRa of the pivot frame 4fR. In the present embodiment, the upper seat frame 5aL is welded to the left end of the cross frame 4h, while the upper seat frame 5aR is welded to the right end of the cross frame 4h.

The lower seat frame 5bL is connected to the pivot frame 4fL and extends obliquely upward and backward. In the present embodiment, the lower seat frame 5bL is welded to the support portion 4fa and its vicinity on the pivot frame 4fL. The lower seat frame 5bR is connected to the pivot frame 4fR and extends obliquely upward and backward. In the present embodiment, the lower seat frame 5bR is welded to the support portion 4fa and its vicinity on the pivot frame 4fR.

The seat bridge frames 5c couple the upper and lower seat frames 5aL and 5bL in a truss pattern. The seat bridge frames 5c couple the upper and lower seat frames 5aR and 5bR in a truss pattern.

The seat cross frames 5d extend in the leftward/rightward direction and couple the upper seat frames 5aL and 5aR. The seat cross frames 5d, extending in the leftward/rightward direction, also couple the lower seat frames 5bL and 5bR.

As shown in FIG. 1, the motorcycle 1 includes a steering shaft 11, a handle bar 12, and a front suspension 6 including a pair of front forks 6L and 6R. The steering shaft 11 is rotatably inserted into the head pipe 4a. The handle bar 12 is mounted to an upper bracket located atop the steering shaft 11. The upper portions of the front forks 6L and 6R are connected to upper and lower brackets located respectively at the top and bottom of the steering shaft 11. The front fork 6L is located to the left of the steering shaft 11, while the front fork 6R is located to the right of the steering shaft 11. The lower portions of the front forks 6L and 6R rotatably support the front wheel 2. The rider can turn the handle bar 12 to steer the front wheel 2 via the steering shaft 11 and the front forks 6L and 6R.

The motorcycle 1 includes a swing arm 13 extending in the forward/backward direction. As shown in FIG. 4, the swing arm 13 includes, at its front, mounting portions 13L and 13R spaced apart in the leftward/rightward direction. Each of the mounting portions 13L and 13R includes a through hole that supports a shaft extending in the leftward/rightward direction, with the shaft being rotatable about its own axis. Each mounting portion 13L or 13R may include a bearing within the through hole.

The mounting portion 13L of the swing arm 13 is mounted to the support portion 4fa of the pivot frame 4fL using a bolt and a nut. The bolt extends through the through hole of the mounting portion 13L and the support portion 4fa of the pivot frame 4fL in the leftward/rightward direction, and the nut is tightened onto the bolt from the outside of the mounting portion 13L or support portion 4fa. The mounting portion 13R of the swing arm 13 is mounted to the support portion 4fa of the pivot frame 4fR using a bolt and a nut. The bolt extends through the through hole of the mounting portion 13R and the support portion 4fa of the pivot frame 4fR in the leftward/rightward direction, and the nut is tightened onto the bolt from the outside of the mounting portion 13R or support portion 4fa. Thus, the front of the swing arm 13 can pivot relative to the pivot frames 4fL and 4fR about the axes of the through holes of the mounting portions 13L and 13R or the axes of the support portions 4fa. The rear of the swing arm 13 rotatably supports the rear wheel 3 serving as a drive wheel.

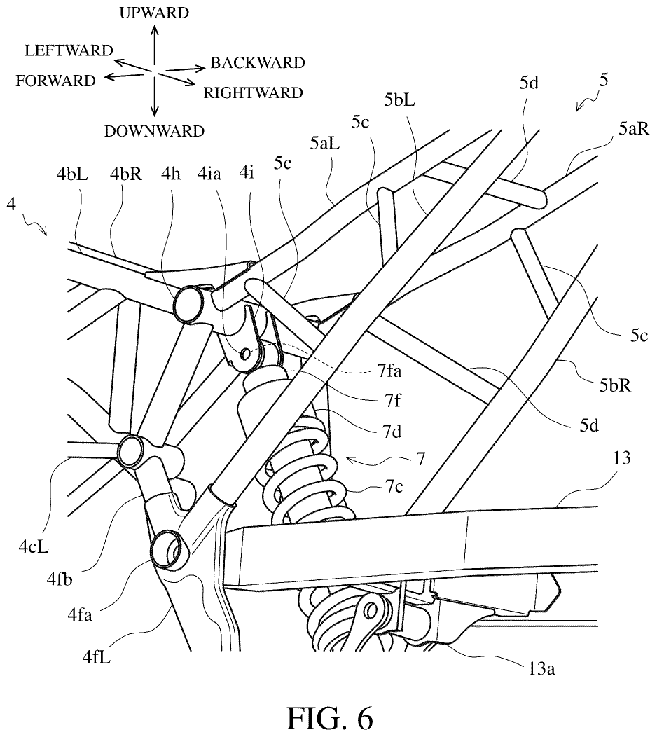

As shown in FIGS. 2 and 3, the rear suspension 7 is pivotally connected at its upper end to the cross frame 4h and at its lower end to the swing arm 13. The motorcycle 1 includes a suspension bracket 4i extending downward from the cross frame 4h. FIG. 6 is a perspective view of the vehicle body frame 4 of the motorcycle 1 of FIG. 1 as viewed obliquely from below. As shown in FIG. 6, in the present embodiment, the suspension bracket 4i is welded to the cross frame 4h. The upper end of the rear suspension 7 is pivotally connected to the suspension bracket 4i.

As shown in FIGS. 2 and 3, the motorcycle 1 includes a link structure 14. The lower end of the rear suspension 7 extends below the swing arm 13. The link structure 14 connects this lower end of the rear suspension 7 to the swing arm 13. The details of the rear suspension 7 and the link structure 14 will be described later.

As shown in FIG. 1, the motorcycle 1 includes a fuel tank 21 located in a space between the upper main frames 4bL and 4bR. The fuel tank 21 is supported by the upper main frames 4bL and 4bR and protrudes above them.

The motorcycle 1 includes a seat 22 astride which the rider is seated. The seat 22 is located behind the fuel tank 21. The seat 22 is supported from below by the upper seat frames 5aL and 5aR of the seat frame 5.

The motorcycle 1 includes an internal combustion engine E. The internal combustion engine E is located in a space bounded by the lower main frames 4cL and 4cR, the down frames 4dL and 4dR, the lower frames 4eL and 4eR, and the pivot frames 4fL and 4fR. The internal combustion engine E is fastened to the vehicle body frame 4 at two or more points.

In the present embodiment, the internal combustion engine E is a reciprocating engine. The internal combustion engine E includes a crankcase Ea and a cylinder block Eb extending upward from the top of the crankcase Ea. The cylinder block Eb includes one or more cylinder bores, inside each of which a piston is slidably mounted. The crankcase Ea includes a crankshaft connected to the pistons via connecting rods. The internal combustion engine E generates drive power by repeating explosive combustion of an air-fuel mixture composed of fuel gas and air in the cylinder bores. The internal combustion engine E converts the explosive combustion-induced reciprocating motion of the pistons to rotational motion of the crankshaft, and transmits the rotational power of the crankshaft to the rear wheel 3 through a power transmission component 23 such as a chain or belt.

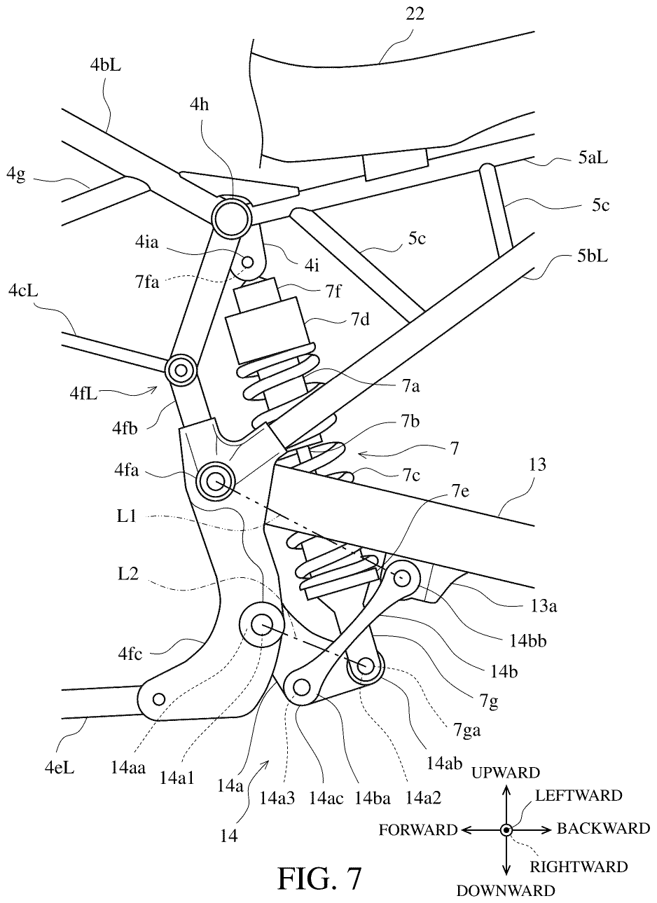

FIG. 7 is an enlarged left side view showing the rear suspension 7 and its vicinity on the vehicle body frame 4 of FIG. 2. As shown in FIG. 7, the rear suspension 7 includes a cylindrical case 7a, a piston rod 7b, a spring 7c, spring seats 7d and 7e, and mounts 7f and 7g. The piston rod 7b includes a piston and a rod coupled to the piston. The piston and part of the rod of the piston rod 7b are housed within the case 7a. The piston rod 7b is slidable relative to the case 7a along the cylindrical axis of the case 7a. This sliding motion allows the rod to extend outward from or retract into the case 7a.

The first mount 7f is connected to one end of the case 7a, particularly the end opposite to that out of which the piston rod 7b protrudes. The first mount 7f includes a through hole 7fa that supports a shaft extending across the direction of sliding motion of the piston rod 7b, with the shaft being rotatable about its own axis. In the present embodiment, the shaft extends perpendicular to the sliding direction of the piston rod 7b. The first mount 7f may include a bearing within the through hole 7fa. The first mount 7f is an example of the claimed second mount.

The second mount 7g is connected to the distal end of the rod of the piston rod 7b. The second mount 7g includes a through hole 7ga that supports a shaft extending across the direction of sliding motion of the piston rod 7b, with the shaft being rotatable about its own axis. In the present embodiment, the shaft extends perpendicular to the sliding direction of the piston rod 7b. The second mount 7g may include a bearing within the through hole 7ga. The second mount 7g is an example of the claimed first mount.

The first spring seat 7d is attached to the case 7a or the first mount 7f. The first spring seat 7d may be integrated with or removable from the case 7a or the first mount 7f. The second spring seat 7e is attached to the second mount 7g. The second spring seat 7e may be integrated with or removable from the second mount 7g. The spring 7c is a coil spring held by the spring seats 7d and 7e therebetween, with the piston rod 7b passing through the interior of the coil.

Either of the mounts 7f and 7g is attached to the suspension bracket 4i. In the present embodiment, the first mount 7f is attached to the suspension bracket 4i. As shown in FIG. 6, the suspension bracket 4i includes a portion with a U-shaped profile. The suspension bracket 4i includes two plate portions facing each other and protruding downward. Each of the two plate portions includes a through hole 4ia. The first mount 7f is located between the two plate portions of the suspension bracket 4i and attached to the suspension bracket 4i using a bolt and a nut. The bolt extends through the through holes 4ia of the two plate portions and the through hole 7fa of the first mount 7f in the leftward/rightward direction, and the nut is tightened onto the bolt from the outside of one of the plate portions. Thus, the rear suspension 7 can pivot about the axis of the through hole 7fa or each through hole 4ia.

As shown in FIG. 7, the link structure 14 includes a first link 14a and a second link 14b. The first link 14a is pivotally connected to the pivot frames 4fL and 4fR and to the lower end of the rear suspension 7. The second link 14b is pivotally connected to the first link 14a and the swing arm 13.

The first link 14a includes through holes 14a1, 14a2, and 14a3. Each of the through holes 14a1, 14a2, and 14a3 extends in the leftward/rightward direction and supports a shaft extending in the leftward/rightward direction, with the shaft being rotatable about its own axis. The first link 14a may include bearings within the through holes 14a1, 14a2, and 14a3. The through hole 14a1 is located at one end portion 14aa of the first link 14a, while the through hole 14a2 is located at the opposite end portion 14ab of the first link 14a. The first link 14a includes a bent portion 14ac between the end portions 14aa and 14ab, and the through hole 14a3 is located at the bent portion 14ac. The first link 14a is curved at the bent portion 14ac. The direction from the through hole 14a1 toward the through hole 14a3 intersects the direction from the through hole 14a2 toward the through hole 14a3. The end portion 14aa is an example of the claimed tubular portion.

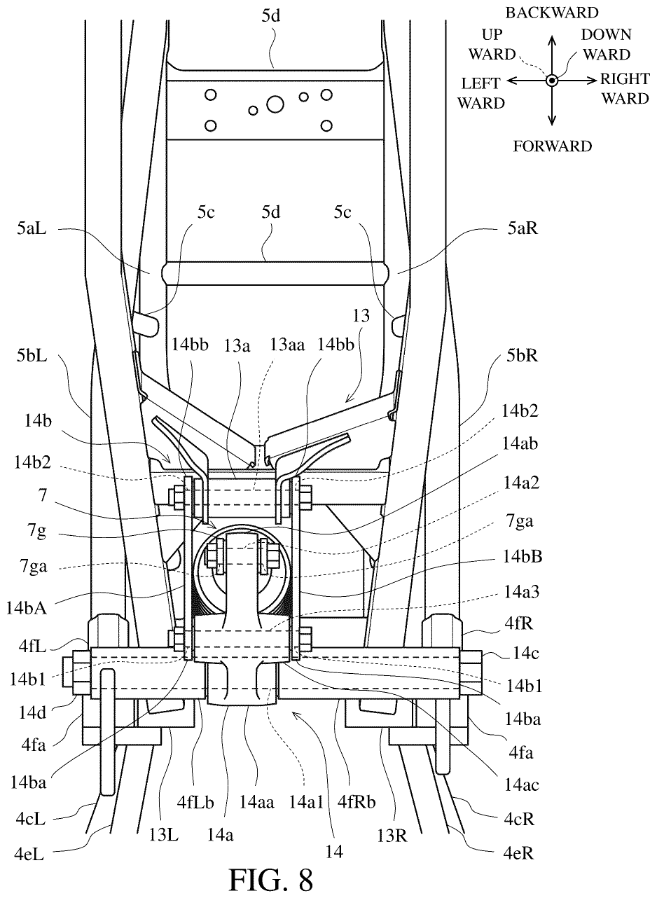

FIG. 8 is a plan view showing the vehicle body frame 4 of the motorcycle 1 of FIG. 1 as viewed from below. As shown in FIG. 8, the end portion 14aa of the first link 14a is pivotally connected to the cylindrical portion 4fLb of the pivot frame 4fL and the cylindrical portion 4fRb of the pivot frame 4fR. The end portion 14aa is located in a gap between the cylindrical portions 4fLb and 4fRb. The end portion 14aa is fastened to the cylindrical portions 4fLb and 4fRb using a bolt 14c and a nut 14d. The bolt 14c extends through the through hole 14a1 of the end portion 14aa and the cylindrical portions 4fLb and 4fRb in the leftward/rightward direction, and the nut 14d is tightened onto the bolt 14c from the outside of the cylindrical portion 4fLb or 4fRb. This configuration allows the first link 14a to pivot relative to the cylindrical portions 4fLb and 4fRb about the axis of the through hole 14a1 of the end portion 14aa or the axes of the cylindrical portions 4fLb and 4fRb. Since the end portion 14aa is coaxial with the cylindrical portions 4fLb and 4fRb, the downward protrusion of the end portion 14aa relative to the cylindrical portions 4fLb and 4fRb is minimized.

The end portion 14ab of the first link 14a is pivotally attached to the second mount 7g of the rear suspension 7. The first link 14a is positioned with its bent portion 14ac protruding forward. In the present embodiment, the second mount 7g, like the suspension bracket 4i, includes an end portion with a U-shaped profile. The second mount 7g includes two plate portions facing each other and protruding outward in the direction in which the piston rod 7b extends. Each of the two plate portions includes a through hole 7ga. The end portion 14ab is located between the two plate portions of the second mount 7g and fastened to the second mount 7g using a bolt and nut. The bolt extends through the through holes 7ga of the two plate portions and the through hole 14a2 of the end portion 14ab in the leftward/rightward direction, and the nut is tightened onto the bolt from the outside of one of the plate portions. This configuration allows the rear suspension 7 and the first link 14a to pivot relative to each other about the axes of the through holes 7ga or the axis of the through hole 14a2.

The second link 14b includes two link components 14bA and 14bB located, respectively, to the left and right of the first link 14a. Each of the link components 14bA and 14bB includes one end portion 14ba with a through hole 14b1 and an opposite end portion 14bb with a through hole 14b2. Each of the through holes 14b1 and 14b2 extends in the leftward/rightward direction and supports a shaft extending in the leftward/rightward direction, with the shaft being rotatable about its own axis. Each of the link components 14bA and 14bB may include a bearing within the through hole 14b1 or 14b2. In the present embodiment, the link components 14bA and 14bB are shaped as plates.

The end portions 14ba of the link components 14bA and 14bB are pivotally attached to the bent portion 14ac of the first link 14a. The end portions 14ba of the link components 14bA and 14bB are located on both sides of the bent portion 14ac in the leftward/rightward direction, and are fastened to the bent portion 14ac using a bolt and a nut. The bolt extends through the through holes 14b1 of the end portions 14ba of the link components 14bA and 14bB and the through hole 14a3 of the bent portion 14ac of the first link 14a in the leftward/rightward direction, and the nut is tightened onto the bolt from the outside of the link component 14bA or 14bB. This configuration allows the link components 14bA and 14bB and the first link 14a to pivot relative to each other about the axes of the through holes 14b1 or the axis of the through hole 14a3.

The end portions 14bb of the link components 14bA and 14bB are pivotally attached to the swing arm 13. The swing arm 13 includes a connection portion 13a located behind the mounting portions 13L and 13R. The connection portion 13a protrudes below the mounting portions 13L and 13R. The connection portion 13a includes a through hole 13aa extending in the leftward/rightward direction. The connection portion 13a may include a bearing within the through hole 13aa. The end portions 14bb of the link components 14bA and 14bB are located on both sides of the connection portion 13a in the leftward/rightward direction, and are fastened to the connection portion 13a using a bolt and a nut. The bolt extends through the through holes 14b2 of the end portions 14bb of the link components 14bA and 14bB and the through hole 13aa of the connection portion 13a in the leftward/rightward direction, and the nut is tightened onto the bolt from the outside of the link component 14bA or 14bB. This configuration allows the link components 14bA and 14bB to pivot relative to the swing arm 13 about the axes of the through holes 14b2 or the axis of the through hole 13aa.

The link structure 14 described above can reduce the inclination of the axis of the rear suspension 7 relative to the vertical direction. The axial direction of the rear suspension 7 corresponds to the direction in which the piston rod 7b extends and retracts.

As seen from FIGS. 7 and 8, the swinging motion of the swing arm 13 is transmitted to the second mount 7g at the lower end of the rear suspension 7 via the second link 14b and the first link 14a, allowing the rear suspension 7 to extend or contract and pivot. The connection portion 13a of the swing arm 13 pivots about the support portions 4fa of the pivot frames 4fL and 4fR along the circumference of a circle with a radius corresponding to the distance L1 between the support portions 4fa and the connection portion 13a. The second mount 7g of the rear suspension 7 pivots about the cylindrical portions 4fLb and 4fRb of the pivot frames 4fL and 4fR along the circumference of a circle with a radius corresponding to the distance L2 between the cylindrical portions 4fLb and 4fRb and the through hole 14a2 of the first link 14a.

In the present embodiment, the distance L2 is smaller than the distance L1. Accordingly, the amount of pivotal motion of the second mount 7g of the rear suspension 7 can be smaller than the amount of pivotal motion of the connection portion 13a of the swing arm 13. Furthermore, the second link 14b and the first link 14a convert the pivotal motion of the connection portion 13a to a smaller pivotal motion, which is then transmitted to the second mount 7g. As a result, changes in the inclination of the axis of the rear suspension 7 during the swinging motion of the swing arm 13 are minimized.

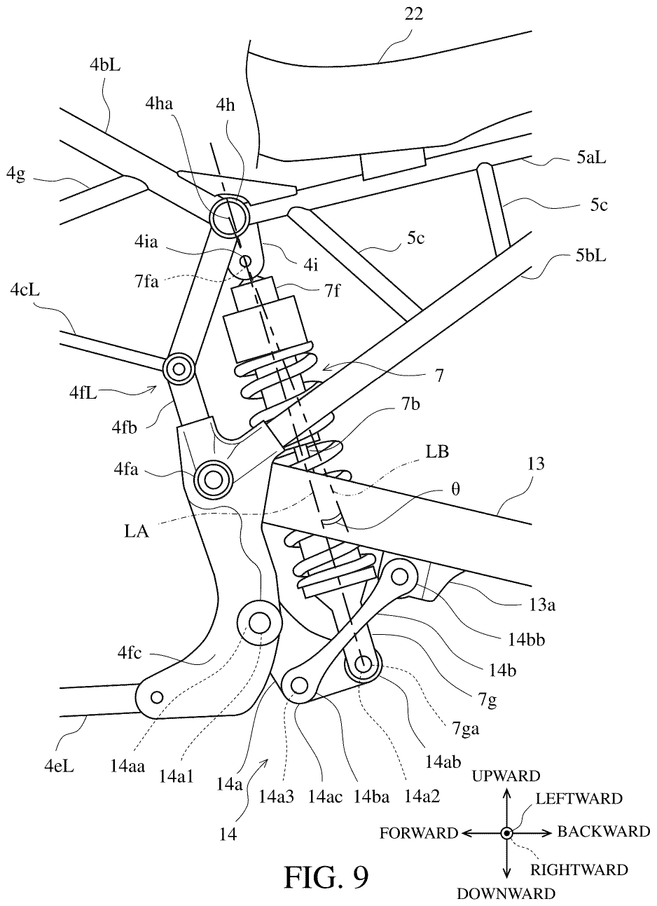

The straddle vehicle 1 according to the present embodiment described above allows the rear suspension 7 to assume the positions described below. FIG. 9 is a left side view showing the rear suspension 7 and its neighboring components, similarly to FIG. 7.

As shown in FIG. 9, in a side view of the straddle vehicle 1, the rear suspension 7 assumes a first position in which a line LA extending from the pivotal axis of the first mount 7f to the pivotal axis of the second mount 7g passes through the cross frame 4h. The pivotal axis of the first mount 7f corresponds to the axis of the through hole 7fa of the first mount 7f or the axis of the through hole 4ia of the suspension bracket 4i. The pivotal axis of the second mount 7g corresponds to the axis of the through hole 7ga of the second mount 7g or the axis of the through hole 14a2 of the end portion 14ab of the first link 14a.

In the present embodiment, the rear suspension 7 satisfies the conditions of the first position when the straddle vehicle 1 is resting on the ground surface in an unloaded state with no rider seated astride the seat 22. Furthermore, the rear suspension 7 satisfies the conditions of the first position when the straddle vehicle 1 is resting on the ground surface in a 1G state with a rider seated astride the seat 22. The 1G state refers to a state in which a rider of average adult male weight is seated astride the seat 22 with both feet on the ground surface. For example, the average weight may be 60 kg. The 1G state is an example of the claimed state in which the straddle vehicle 1 is resting on the ground surface.

With this feature, the moment applied from the first mount 7f of the rear suspension 7 to the suspension bracket 4i is minimized. This moment acts in a rotational direction about the axis 4ha of the cross frame 4h. Thus, the strength required to mount the suspension bracket 4i to the cross frame 4h can be kept low. The axis 4ha of the cross frame 4h is a central axis extending straight in the leftward/rightward direction.

The rear suspension 7 may satisfy the conditions of the first position during its extension or contraction. The extension and contraction of the rear suspension 7 include any motion occurring between a fully extended (full extension stroke) state where the rear suspension 7 mounted on the straddle vehicle 1 is fully extended and a fully contracted (full contraction stroke) state where the rear suspension 7 is fully contracted.

In the present embodiment, in a side view of the straddle vehicle 1 in the 1G state, the rear suspension 7 assumes a second position in which the axis 4ha of the cross frame 4h, the pivotal axis of the first mount 7f, and the pivotal axis of the second mount 7g are aligned along a straight line. As a result, the moment applied from the first mount 7f of the rear suspension 7 to the suspension bracket 4i is minimized.

In the present embodiment, in a side view of the straddle vehicle 1 during extension or contraction of the rear suspension 7, the angle θ between the line LA and a line LB extending from the axis 4ha of the cross frame 4h to the pivotal axis of the first mount 7f of the rear suspension 7 is 20° or less, preferably 15° or less, and more preferably 10° or less. The extension and contraction of the rear suspension 7 include any motion occurring between the full extension stroke state and the full contraction stroke state of the rear suspension 7 mounted on the straddle vehicle 1.

Thus, even when the rear suspension 7 is extending or contracting in response to the swinging motion of the swing arm 13, the deviation between the directions of the lines LA and LB remains small. As a result, the moment applied from the first mount 7f of the rear suspension 7 to the suspension bracket 4i is minimized.

### Variants

Although the foregoing has described an exemplary embodiment of the present disclosure, the present disclosure is not limited to this embodiment. Various changes and modifications may be made without departing from the scope of the present disclosure. For example, the scope of the present disclosure encompasses embodiments resulting from various changes made to the above embodiment or constructed by combining the elements of different embodiments.

For example, in the above embodiment, the cross frame 4h is connected to the upper main frames 4bL and 4bR and to the pivot frames 4fL and 4fR, thereby coupling the upper main frames 4bL and 4bR to each other and the pivot frames 4fL and 4fR to each other. However, the cross frame 4h is not limited to this configuration. For example, the cross frame 4h may be connected to the upper main frames 4bL and 4bR to couple them together, without being connected to the pivot frames 4fL and 4fR. Alternatively, the cross frame 4h may be connected to the pivot frames 4fL and 4fR to couple them together, without being connected to the upper main frames 4bL and 4bR. The cross frame 4h may be connected to the lower main frames 4cL and 4cR to couple them together, in addition to or instead of being connected to the upper main frames 4bL and 4bR.

Although the motorcycle 1 of the above embodiment includes the upper main frames 4bL and 4bR and the lower main frames 4cL and 4cR, the motorcycle 1 is not limited to this configuration. For example, the motorcycle 1 may include at least the upper main frames 4bL and 4bR, the pivot frames 4fL and 4fR, and the cross frame 4h. The upper main frames 4bL and 4bR may be integrated into a single frame. The pivot frames 4fL and 4fR may likewise be integrated into a single frame.

For example, the motorcycle 1 need not include the lower main frames 4cL and 4cR. The down frames 4dL and 4dR may be integrated into a single frame. The internal combustion engine E may serve as a structural frame component of the motorcycle 1. In such a case, the motorcycle 1 does not need to include the lower frames 4eL and 4eR and may be without the lower frames 4eL and 4eR and the down frames 4dL and 4dR.

Aspects of the technology according to the present disclosure are listed below. A straddle vehicle according to a first aspect of the present disclosure includes: a pair of top frames extending in a forward/backward direction of the straddle vehicle; a pair of pivot frames each of which is connected to a rear end of a corresponding one of the pair of top frames, the pivot frames extending in a downward direction of the straddle vehicle; a cross frame extending in a leftward/rightward direction of the straddle vehicle and coupling the pair of top frames or the pair of pivot frames to each other; a swing arm pivotally coupled to the pair of pivot frames and supporting a rear wheel of the straddle vehicle; a bracket extending from the cross frame in the downward direction; and a rear suspension having an upper end and a lower end, the rear suspension being pivotally connected at the upper end to the bracket and at the lower end to the swing arm, wherein in a side view of the straddle vehicle, a first line extending from a pivotal axis of the upper end of the rear suspension to a pivotal axis of the lower end of the rear suspension passes through the cross frame.

According to the first aspect, in a side view of the straddle vehicle, the deviation between the direction of the first line and the direction of another line extending from the axis of the cross frame toward the pivotal axis of the upper end of the rear suspension is small. As a result, the moment applied from the rear suspension to the bracket in a rotational direction about the cross frame is minimized. Accordingly, despite being simple, the structure for mounting the bracket to the cross frame can have sufficient strength to support the rear suspension.

The straddle vehicle according to a second aspect of the present disclosure which is based on the first aspect may be configured such that in a side view of the straddle vehicle resting on a ground surface, an axis of the cross frame, the pivotal axis of the upper end of the rear suspension, and the pivotal axis of the lower end of the rear suspension are aligned along a straight line.

According to the second aspect, the deviation between the first line and the direction of the line extending from the axis of the cross frame toward the pivotal axis of the upper end of the rear suspension is significantly small. As a result, the moment applied from the rear suspension to the bracket in a rotational direction about the cross frame can be minimized.

The straddle vehicle according to a third aspect of the present disclosure which is based on the first or second aspect may be configured such that in a side view of the straddle vehicle during extension or contraction of the rear suspension, an angle between the first line and a second line extending from an axis of the cross frame to the pivotal axis of the upper end of the rear suspension is 20° or less.

According to the third aspect, the deviation between the directions of the first and second lines remains small even when the rear suspension is extending or contracting in response to swinging motion of the swing arm. As a result, the moment applied from the extending or contracting rear suspension to the bracket in the rotational direction about the cross frame can be minimized.

The straddle vehicle according to a fourth aspect of the present disclosure which is based on any one of the first to third aspects may be configured such that: the the rear suspension includes a cylindrical case, a piston rod housed in part in the case, the piston rod being slidable relative to the case to extend from or retract into the case, a first mount located at an end of the piston rod, and a second mount located at an end of the case; the piston rod extends or retracts along a direction from the first mount toward the second mount; one of the first and second mounts is pivotally connected to the bracket; and the other of the first and second mounts is pivotally connected to the swing arm.

According to the fourth aspect, the piston rod extends or retracts along the direction from the first mount toward the second mount. Thus, the direction of extension or contraction of the piston rod coincides with or is close to the direction of the first line. Since the direction of the force applied from the rear suspension to the bracket is the direction of extension or contraction of the rear suspension, the moment applied to the bracket in the rotational direction about the cross frame can be minimized.

The straddle vehicle according to a fifth aspect of the present disclosure which is based on any one of the first to fourth aspects may further include: a seat on which a rider is seated; and a seat frame supporting the seat, the seat frame extending in the forward/backward direction of the straddle vehicle and being connected to the pair of top frames, and the cross frame may be located at a junction between the pair of top frames and the seat frame.

According to the fifth aspect, the cross frame can support the top frames, the seat frame, and the pivot frames. Such a cross frame has a strong structure. The rear suspension can be securely supported, as the upper end of the rear suspension is supported by the cross frame via the bracket.

The straddle vehicle according to a sixth aspect of the present disclosure which is based on any one of the first to fifth aspects may be configured such that the lower end of the rear suspension extends below the swing arm, and the straddle vehicle further includes a link structure connecting the lower end of the rear suspension to the swing arm.

According to the sixth aspect, the rear suspension is located in proximity to the pivot frames and can assume a nearly upright position. This can minimize changes in the position of the rear suspension during swinging motion of the swing arm. As a result, it is easy to allow the first line to pass through the rear suspension even during extension or contraction of the rear suspension. Furthermore, since the lower end of the rear suspension extends below the swing arm, the length of the rear suspension can be increased. The long rear suspension can extend or contract over a long stroke, allowing the rear wheel to conform to the irregularities of the ground surface. As a result, the straddle vehicle can run stably.

The straddle vehicle according to a seventh aspect of the present disclosure which is based on the sixth aspect may be configured such that the link structure includes: a first link pivotally connected to the pair of pivot frames and the lower end of the rear suspension; and a second link pivotally connected to the first link and the swing arm.

According to the seventh aspect, the first link defines the movement trajectory of the lower end of the rear suspension, while the second link limits the range of pivotal motion of the first link. This can minimize changes in the position of the rear suspension during swinging motion of the swing arm.

The straddle vehicle according to an eighth aspect of the present disclosure which is based on the seventh aspect may further include a pair of bottom frames each of which extends from a corresponding one of the pair of pivot frames in the leftward/rightward direction of the straddle vehicle, the bottom frames protruding toward each other and being spaced apart by a gap in the leftward/rightward direction, and the first link may be located between, and pivotally connected to, the pair of bottom frames.

According to the eighth aspect, the structure for securing the first link to the pivot frames can be simplified. For example, a bracket for mounting the first link to the pivot frames is unnecessary. In this configuration, where the first link is located between the pair of bottom frames, space can be saved compared to configurations in which the first link is located radially away from the pair of bottom frames.

The straddle vehicle according to a ninth aspect of the present disclosure which is based on the eighth aspect may be configured such that: each of the pair of bottom frames is tubular; the first link includes a tubular portion held between respective end portions of the pair of bottom frames, the end portions being opposed to each other; and the straddle vehicle further includes a bolt extending through the tubular portion and the pair of bottom frames in the leftward/rightward direction of the straddle vehicle and pivotally connecting the first link to the pair of bottom frames, and a nut tightened on the bolt from outside of the pair of bottom frames in the leftward/rightward direction of the straddle vehicle.

According to the ninth aspect, the first link is pivotally secured to the pair of bottom frames by inserting the bolt through the pair of bottoms frames and the tubular portion located between the bottom frames, and by tightening the nut onto the bolt from the outside of the pair of bottoms frames. Thus, the structure and the process for securing the first link to the pivot frames can be simplified.

The numerals such as ordinal and cardinal numbers as used herein are all provided by way of example to describe the technology of the present disclosure in concrete terms and not intended to limit the present disclosure. The described connection relationships between the elements are also examples for illustrating the technology of the present disclosure in concrete terms, and any other connection relationships may be employed to achieve the functionality disclosed herein.

The scope of the present disclosure is defined by the appended claims rather than by the specification so that the disclosed technology may be embodied in various forms without departing from the essential characteristics of the present disclosure. The exemplary embodiment and variants are meant to be illustrative only and not limiting as to the scope of the present disclosure. All changes which come within the meaning and range of equivalency of the claims are to be embraced by the claims.

What is claimed is:

1. A straddle vehicle comprising:
a pair of top frames extending in a forward/backward direction of the straddle vehicle;
a pair of pivot frames each of which is connected to a rear end of a corresponding one of the pair of top frames, the pivot frames extending in a downward direction of the straddle vehicle;
a cross frame extending in a leftward/rightward direction of the straddle vehicle and coupling the pair of top frames or the pair of pivot frames to each other;
a swing arm pivotally coupled to the pair of pivot frames and supporting a rear wheel of the straddle vehicle;
a bracket extending from the cross frame in the downward direction; and
a rear suspension having an upper end and a lower end, the rear suspension being pivotally connected at the upper end to the bracket and at the lower end to the swing arm, wherein
in a side view of the straddle vehicle, a first line extending from a pivotal axis of the upper end of the rear suspension to a pivotal axis of the lower end of the rear suspension passes through the cross frame.

2. The straddle vehicle according to claim 1, wherein in a side view of the straddle vehicle resting on a ground surface, an axis of the cross frame, the pivotal axis of the upper end of the rear suspension, and the pivotal axis of the lower end of the rear suspension are aligned along a straight line.

3. The straddle vehicle according to claim 1, wherein in a side view of the straddle vehicle during extension or contraction of the rear suspension, an angle between the first line and a second line extending from an axis of the cross frame to the pivotal axis of the upper end of the rear suspension is 20° or less.

4. The straddle vehicle according to claim 1, wherein
the rear suspension includes:
a cylindrical case;
a piston rod housed in part in the case, the piston rod being slidable relative to the case to extend from or retract into the case;
a first mount located at an end of the piston rod; and
a second mount located at an end of the case,
the piston rod extends or retracts along a direction from the first mount toward the second mount,
one of the first and second mounts is pivotally connected to the bracket, and
the other of the first and second mounts is pivotally connected to the swing arm.

5. The straddle vehicle according to claim 1, further comprising:
a seat on which a rider is seated; and
a seat frame supporting the seat, the seat frame extending in the forward/backward direction of the straddle vehicle and being connected to the pair of top frames, wherein the cross frame is located at a junction between the pair of top frames and the seat frame.

6. The straddle vehicle according to claim 1, wherein
the lower end of the rear suspension extends below the swing arm, and
the straddle vehicle further comprises a link structure connecting the lower end of the rear suspension to the swing arm.

7. The straddle vehicle according to claim 6, wherein
the link structure includes:
a first link pivotally connected to the pair of pivot frames and the lower end of the rear suspension; and
a second link pivotally connected to the first link and the swing arm.

8. The straddle vehicle according to claim 7, further comprising a pair of bottom frames each of which extends from a corresponding one of the pair of pivot frames in the leftward/rightward direction of the straddle vehicle, the bottom frames protruding toward each other and being spaced apart by a gap in the leftward/rightward direction, wherein
the first link is located between, and pivotally connected to, the pair of bottom frames.

9. The straddle vehicle according to claim 8, wherein
each of the pair of bottom frames is tubular,
the first link includes a tubular portion held between respective end portions of the pair of bottom frames, the end portions being opposed to each other, and
the straddle vehicle further comprises:
a bolt extending through the tubular portion and the pair of bottom frames in the leftward/rightward direction of the straddle vehicle and pivotally connecting the first link to the pair of bottom frames; and
a nut tightened on the bolt from outside of the pair of bottom frames in the leftward/rightward direction of the straddle vehicle.
